(19) United States
(12) Patent Application Publication
(10) Pub. No.: US 2024/0318752 A1
(43) Pub. Date: Sep. 26, 2024

(54) WATER PIPE ADAPTER, A TANK ASSEMBLY, AND A TOILET APPARATUS

(71) Applicant: Kohler (China) Investment Co., Ltd., Shanghai (CN)

(72) Inventor: Jun Zhang, Shanghai (CN)

(21) Appl. No.: 18/584,677

(22) Filed: Feb. 22, 2024

(30) Foreign Application Priority Data
Mar. 23, 2023 (CN) 202320594916.9

(51) Int. Cl. F16L 27/087; E03C 1/30

(52) U.S. Cl. CPC F16L 27/087; E03C 1/30

(57) ABSTRACT

A water pipe adapter includes a first joint including a position-limiting projection part configured to be connected to a water pipe. The water pipe adapter also includes a second joint, connected to the first joint and including a joint position-limitation part configured to be engaged with an interface position-limitation part of an inlet or an interface position-limitation part of an outlet. The second joint is configured to be pivotably disposed in the inlet or the outlet.

### CROSS REFERENCE TO RELATED APPLICATION

This application claims the benefit of priority to: Chinese Patent Application No. 202320594916.9 filed in the Chinese Intellectual Property Office on Mar. 23, 2023, which is hereby incorporated by reference in its entirety.

### FIELD

The present disclosure is related to the technical field of water pipe connection accessories and in particular is related to a water pipe adapter, a tank assembly, and a toilet apparatus.

### BACKGROUND

In the sanitary industry, a water pipe adapter is often used to connect water pipes. Water pipe adapters for components, such as an inlet valve, an outlet valve, and a dissolver, are all fixed structures and installed in fixed directions. A water pipe is connected between the inlet valve and the dissolver. A water pipe is connected between the dissolver and the outlet valve. When a valve core of the outlet valve moves up and down, the water pipe connected to the valve core will moves up and down correspondingly. There are possibilities that interferences between two water pipes in the fixed directions may occur, and thus normal movements of the moveable components may be affected.

In view of the above defects, it is necessary to provide a new type of a water pipe adapter, a tank assembly, and a toilet apparatus.

### SUMMARY

The object of the present disclosure is to overcome the above defects by providing a water pipe adapter, a tank assembly, and a toilet apparatus. A first joint and a second joint of the water pipe adapter are arranged at an obtuse angle. A direction of the first joint can be adjusted by rotating the second joint, and thus a position or a direction of a water pipe connected to the first joint may be adjusted. Thus, interferences between water pipes may be avoided.

According to an embodiment of the present disclosure, a water pipe adapter includes a first joint configured to be connected to a water pipe and includes a second joint configured to be pivotably mounted (e.g., disposed) in an inlet or an outlet.

The first joint is connected to the second joint and obliquely extends toward one side of the second joint, and the angle formed between an axis of the first joint and an axis of the second joint is an obtuse angle.

The first joint includes a position-limiting projection part configured to be connected to the water pipe.

The second joint includes a joint position-limitation part that is fitted with (e.g., engaged with) an interface position-limitation part of the inlet or the outlet.

In another embodiment, the joint position-limitation part is an annular protrusion extending outwards from an outer surface of the second joint. The interface position-limitation part of the inlet is an annular protrusion extending inwards from an inner wall of the inlet. The interface position-limitation part of the outlet is an annular protrusion extending inwards from an inner wall of the outlet.

In another embodiment, an annular groove configured to mount (e.g., receive) a sealing ring is disposed on a circumferential surface of the second joint, and the joint position-limitation part is disposed between the annular groove and the first joint.

In another embodiment, a plurality of annular grooves is disposed at intervals (e.g., spaced apart from each other) on the second joint along an axial direction of the second joint.

In another embodiment, the joint position-limitation part is or includes a joint baffle ring integrally formed on the second joint.

In another embodiment, the position-limiting projection part is or includes a position—limiting projecting ring integrally formed on the first joint, and a ring surface of the position-limiting projecting ring is a slope (e.g., an inclined plane).

The radius of the ring surface gradually increases along a direction from the first joint to the second joint.

In another embodiment, the first joint is injection-molded with the second joint.

The present disclosure further provides a tank assembly comprising a tank, an inlet valve, an outlet valve, a dissolver, and two water pipe adapters as described in any embodiments described above.

The inlet valve, the outlet valve, and the dissolver are mounted in the tank, respectively.

The housing of the dissolver is provided with an inlet and an outlet both having an interface position-limitation part. The second joint of one water pipe adapter is pivotably mounted (e.g., disposed) in the inlet, the second joint of the other water pipe adapter is pivotably mounted in the outlet, and the joint position-limitation part is fitted with (e.g., engaged with) the interface position-limitation part.

The inlet valve is connected to the first joint of the one water pipe adapter mounted in the inlet via a water pipe, the outlet valve is connected to the first joint of the other water pipe adapter mounted in the outlet via another water pipe, and the position-limiting projection parts are fitted with the corresponding water pipes.

In another embodiment, the interface position-limitation part is or includes an interface baffle ring, and the joint position-limitation part is or includes a joint baffle ring.

The inner diameter of the interface baffle ring is less than the outer diameter of the joint baffle ring, and the joint baffle ring is located at an inner side of the interface baffle ring.

In another embodiment, an annular groove is provided on the circumferential surface of the second joint, and a sealing ring is mounted in the annual groove.

The present disclosure further provides a toilet apparatus comprising a tank assembly as described in any of the above technical solutions.

By adopting the above embodiments, the present disclosure achieves the following beneficial technical effects:

The present disclosure provides the water pipe adapter, the tank assembly, and the toilet apparatus. The water pipe adapter includes a first joint and a second joint, with an obtuse angle between the first joint and the second joint. The first joint is configured to connect the water pipe, and the second joint is configured to be mounted in the inlet or the outlet and is rotatable or pivotable. The direction of the first joint can be adjusted by rotating the second joint, and thus the position or the direction of the water pipes may be adjusted. Thus, the interference between the water pipes and the interference between the water pipes and the surrounding components may be avoided. It is more convenient for the user to use the water pipe adapter, the tank assembly, and the toilet apparatus.

### BRIEF DESCRIPTION OF THE FIGURES

By reference to the drawings, the descriptions of the present disclosure should become easier to understand. It should be understood that the drawings are only for demonstration purpose and does not intend to limit the protection scope of the present disclosure. In the drawings:

FIG. 1 is a perspective view in a first angle of view of a water pipe adapter according to an embodiment of the present disclosure;

FIG. 2 is a perspective view in a second angle of view of a water pipe adapter according to an embodiment of the present disclosure;

FIG. 3 is a section view of a water pipe adapter according to an embodiment of the present disclosure;

FIG. 4 is a perspective view of a tank assembly according to an embodiment of the present disclosure;

FIG. 5 is a schematic view of a connection among an inlet valve, a dissolver, and an outlet valve via water pipes;

FIG. 6 is a perspective view of water pipe adapters mounted in an inlet and an outlet of a dissolver;

FIG. 7 is an exploded view of FIG. 6;

FIG. 8 is a partially enlarged view of a housing of a dissolver provided with an inlet and an outlet;

FIG. 9 is a section view of a housing provided with an inlet and an outlet;

FIG. 10 is a perspective view of an inlet valve;

FIG. 11 is a perspective view of an outlet valve;

FIG. 12 is a block diagram of a toilet apparatus, including the water pipe adapter according to an embodiment of the present disclosure;

FIG. 13 is a schematic view of the toilet apparatus according to an embodiment of the present disclosure; and

FIG. 14 is a flow chart of a method for assembling a tank assembly according to an embodiment of the present disclosure.

### DETAILED DESCRIPTION

The embodiments of the present disclosure are illustrated by accompany drawings as below. Like reference number are used for like components. It should be noted that, the terms of “front”, “back”, “left”, “right”, “up”, and “down” used in the following description refer to the directions in the figures, and the terms of “in” and “out” refer to the direction towards or away from the geometric center of a specific component, respectively.

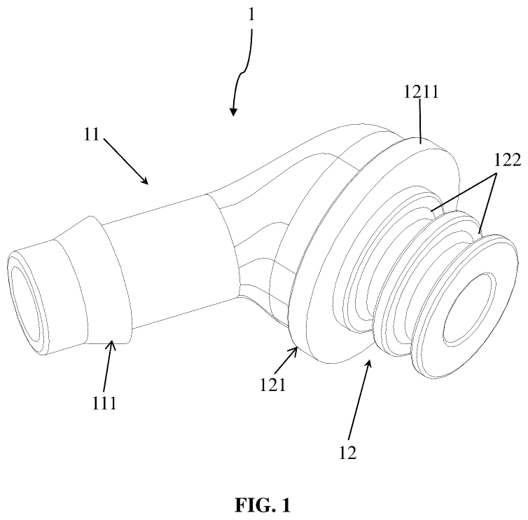

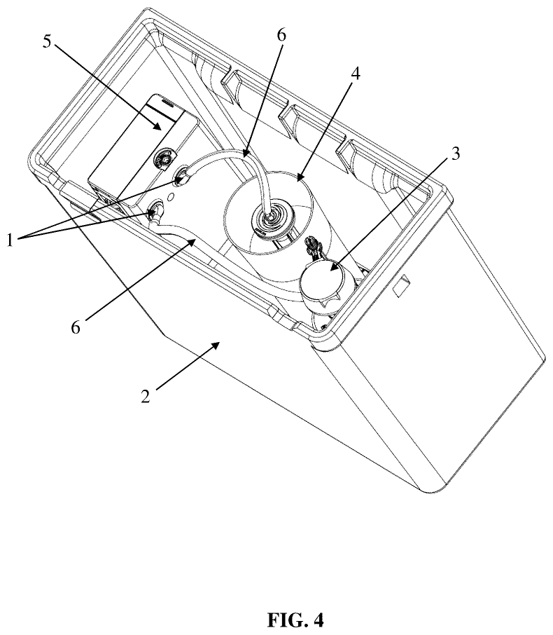

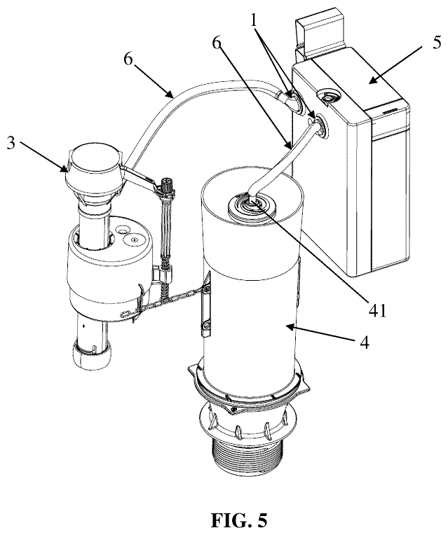

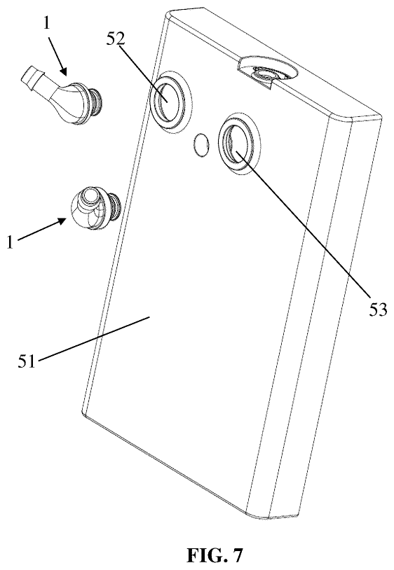

As shown in FIGS. 1-3, a water pipe adapter 1 provided by one embodiment of the present disclosure comprises a first joint 11 configured to be connected to a water pipe (e.g. a water pipe 6 as shown in FIG. 4 and FIG. 5) and comprises a second joint 12 configured to be pivotably mounted in an inlet (e.g., an inlet 52 as shown in FIGS. 7-9) or an outlet (e.g., an outlet 53 as shown in FIGS. 7-9).

The first joint 11 is connected to the second joint 12, the first joint 11 obliquely extends toward one side of the second joint 12, and the angle formed between an axis of the first joint 11 and an axis of the second joint 12 is an obtuse angle.

The first joint 11 comprises a position-limiting projection part 111 configured to be connected to the water pipe.

The second joint 12 comprises a joint position-limitation part 121 configured to fitted with (e.g., engaged with) an interface position-limitation part of the inlet (an inlet 52 as shown in FIGS. 7-9) or an outlet (an outlet 53 as shown in FIGS. 7-9).

The water pipe adapter 1 according to the present disclosure may be a plastic component. The water pipe adapter 1 comprises the first joint 11 and the second joint 12. Both of the first joint 11 and the second joint 12 are in a tubular shape. The first joint 11 is configured to be connected to the water pipe. The first joint 11 comprises the position-limiting projection part 111 configured to be connected to the water pipe. The water pipe may be a flexible hose. After the water pipe is sleeved on the position-limiting projection part 111 of the first joint 11, the water pipe is fixedly connected to the first joint 11.

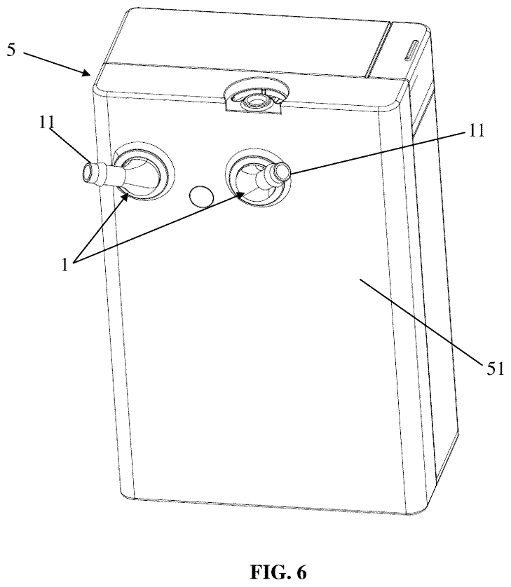

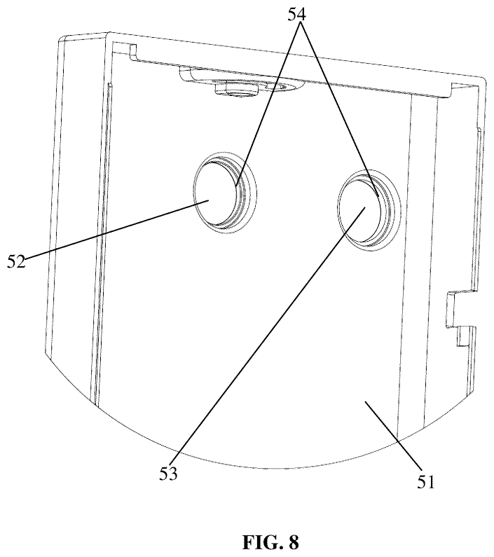

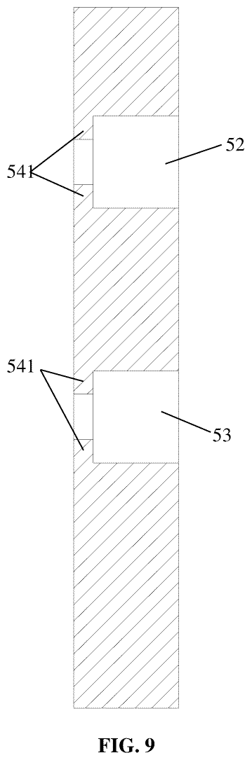

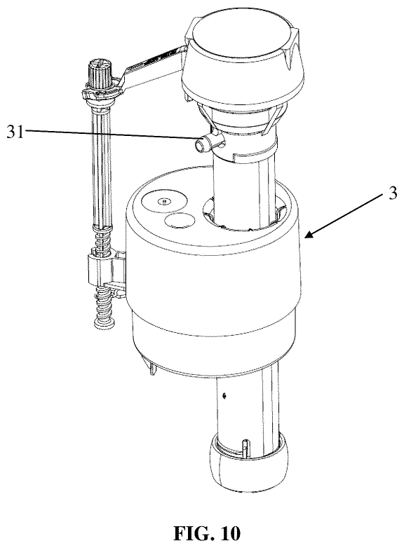

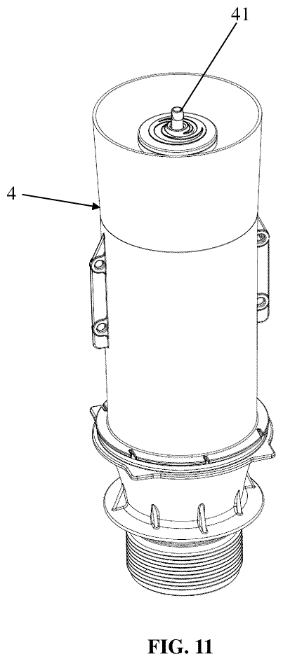

The second joint 12 is configured to be hermetically connected to the inlet or the outlet of a product (e.g., a dissolver 5 as shown in FIGS. 4-6 or a tank assembly as shown in FIGS. 4-8, 10, and 11), and the second joint 12 is rotatable (e.g., pivotable) in and with respect to the inlet or the outlet. The second joint 12 comprises a joint position-limitation part 121 configured to be fitted with (e.g., engaged with) an interface position-limitation part (e.g., an interface position-limitation part 54 as shown in FIG. 8) in the inlet or the outlet, so as to prevent the second joint 12 from being disengaged from the inlet or the outlet. The interface position-limitation part may be or include a step or a baffle ring (e.g., an interface baffle ring 541 as shown in FIG. 9) provided in the inlet or the outlet, and the joint position-limitation part 121 may be or include a step or a baffle ring (e.g., a joint baffle ring 1211 as shown in FIGS. 1-3) provided on the second joint 12. According to the need, a sealing ring may be assembled on the second joint 12 to achieve the sealing between the second joint 12 and the inlet and the sealing between the second joint 12 and the outlet. In an embodiment, the joint position-limitation part 121 is an annular protrusion extending outwards from an outer surface of the second joint 12. The interface position-limitation part 54 of the inlet 52 is an annular protrusion extending inwards from an inner wall of the inlet 52. The interface position-limitation part 54 of the outlet 53 is an annular protrusion extending inwards from an inner wall of the outlet 53.

An end of the first joint 11 is connected to the second joint 12, and the axes of the first joint 11 and the second joint 12 are not aligned in the same line. An obtuse angle is formed between the first joint 11 and the second joint 12. In an embodiment, the obtuse angle may be between 100°-120°. As such, the first joint 11 obliquely extends toward one side of the second joint 12. When the second joint 12 is rotated, the direction and the position of the first joint 11 outside the product can be adjusted, and thus the position or direction of the water pipe can be adjusted. Thus, the interferences between adjacent water pipes and interferences between the water pipes and the surrounding components may be avoided. It is more convenient for the user to use the water pipe adapter, the tank assembly, and the toilet apparatus.

In an embodiment, as shown in FIGS. 1-3, annular grooves 122 configured to mount (e.g., receive) sealing rings are provided on the circumferential surface of the second joint 12, the joint position-limitation part 121 is located between the annular grooves 122 and the first joint 11.

In this embodiment, the annular grooves 122 configured to mount or receive the sealing rings are provided on the second joint 12, so as to fix the sealing rings.

In an embodiment, as shown in FIGS. 1-3, a plurality of annular grooves 122 is provided at intervals (e.g., spaced apart from each other) on the second joint 12 along an axial direction of the second joint. A sealing ring is assembled in each annular groove 122 to improve the sealing effect between the second joint 12 and the inlet and the sealing effect between the second joint 12 and the outlet.

In an embodiment, as shown in FIGS. 1-3, the joint position-limitation part 121 is or include a joint baffle ring 1211 integrally provided or formed on the second joint 12.

The interface position-limitation part is or include an interface baffle ring provided at the openings of the inlet and the outlet. While the product is assembled, the joint baffle ring 1211 is located at an inner side of the interface baffle ring to prevent the joint baffle ring 1211 from moving outwards.

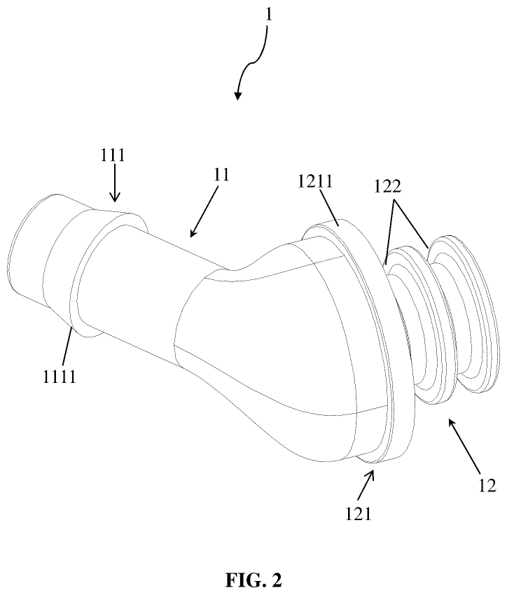

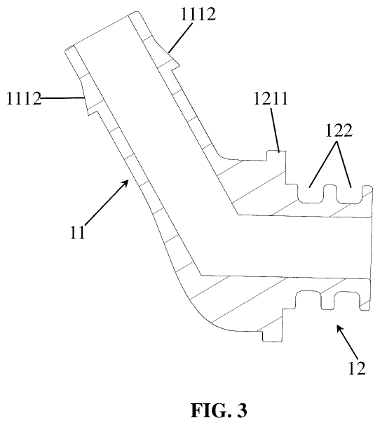

In an embodiment, as shown in FIGS. 2 and 3, the position-limiting projection part 111 is a position-limiting projecting ring 1111 integrally provided or formed on the first joint 11, and the ring surface 1112 of the position-limiting projecting ring 1111 is an inclined plane.

A radius of the ring surface 1112 gradually increases along a direction from the first joint 11 to the second joint 12.

In this embodiment, the position-limiting projection part 111 is or includes a position-limiting projecting ring 1111. The radial section of the position-limiting projecting ring 1111 is wedge-shaped. In other words, the ring surface 1112 of the position-limiting projecting ring 1111 is an inclined plane, and the radius of the ring surface 1112 gradually increases along the direction from the first joint 11 to the second joint 12, such that the water pipe is sleeved on from an end of the first joint 11 to the position-limiting projecting ring 1111. Then, the water pipe is fixed by the position-limiting projecting ring 1111.

In an embodiment, the first joint 11 is injection-molded with the second joint 12. This facilitates machine shaping and results in a high structural strength.

As shown in FIGS. 4-8, 10, and 11, a tank assembly according to an embodiment of the present disclosure comprises a tank 2, an inlet valve 3, an outlet valve 4, a dissolver 5, and two water pipe adapters 1 as described in any of the above embodiments. The above descriptions regarding the water pipe adapter 1 is incorporated herein.

The inlet valve 3, the outlet valve 4, and the dissolver 5 are mounted in the tank 2, respectively.

An inlet 52 and an outlet 53 both having an interface position-limitation part 54 are provided on a housing 51 of the dissolver 5. The second joint 12 of one water pipe adapter 1 (the “first water pipe adapter”) is pivotably mounted in the inlet 52, the second joint 12 of the other water pipe adapter 1 (the “second water pipe adapter”) is pivotably mounted in the outlet 53. Each joint position-limitation part 121 is fitted with (e.g., engaged with) its corresponding interface position-limitation part 54.

The inlet valve 3 is connected to the first joint 11 of the water pipe adapter 1 mounted in the inlet 52 (i.e., the first water pipe adapter) via a water pipe 6 (the “first water pipe”), and the outlet valve 4 is connected to the first joint 11 of the water pipe adapter 1 mounted in the outlet 53 (i.e., the second water pipe adapter) via another water pipe 6 (the “second water pipe”). Each position-limiting projection part 111 is fitted with (e.g., engaged with) its corresponding water pipe 6.

The tank assembly according to the present disclosure is a tank assembly of a toilet, which comprises two water pipe adapters 1, a tank 2, an inlet valve 3, an outlet valve 4, and a dissolver 5.

With respect to the structure and construction of the water pipe adapter 1, the above descriptions for the water pipe adapter 1 are incorporated herein.

The tank 2 is configured to hold water so as to flush the toilet.

The inlet valve 3 is mounted in the tank 2 and configured to control the water supply into the tank 2.

The outlet valve 4 is mounted in the tank 2 and configured to deliver the water to the toilet, so as to rinse or clean the toilet.

The dissolver 5 is mounted in the tank 2 and configured receive and dissolve a solid detergent, so as to form a cleaning liquid or a cleaning solution.

All of the tank 2, the inlet valve 3, the outlet valve 4, and the dissolver 5 may be any products in the prior art, for example, the tank, the inlet valve, the outlet valve, and the dissolver described in the Background section. The descriptions regarding the mounting positions and working manners of working of the tank, the inlet valve, the outlet valve, and the dissolver in the prior art have been omitted herein.

An outlet joint 31 is provided on the inlet valve 3, and an inlet joint 41 is provided on the outlet valve 4.

The inlet 52 and the outlet 53 are provided on the housing 51 of the dissolver 5. The inlet 52 and the outlet 53 each have the interface position-limitation part 54.

The second joint 12 of the first water pipe adapter 1 is pivotably mounted in the inlet 52, and the second joint 12 of the first water pipe adapter 1 may be sealed with the inlet 52 via a sealing ring. The joint position-limitation part 121 is fitted with or engaged with the interface position-limitation part 54 of the first water pipe adapter 1 to prevent the second joint 12 from being disengaged from the inlet 52. The inlet valve 3 is connected to the first joint 11 of the first water pipe adapter 1 via the first water pipe 6. One side of the inlet valve 3 is provided with an outlet joint 31, and the first water pipe 6 is connected between the outlet joint 31 and the first joint 11 of the first water pipe adapter 1. The water from the outlet joint 31 enters the dissolver 5 through the first water pipe 6 and the first water pipe adapter 1, such that the solid detergent is dissolved to form the cleaning liquid or the cleaning solution.

The second joint 12 of the second water pipe adapter 1 is pivotably mounted in the outlet 53, and a seal is formed between the second joint 12 and the inlet 52 via sealing rings. The joint position-limitation part 121 is fitted with or engaged with the interface position-limitation part 54 of the second water pipe adapter 1 to prevent the second joint 12 of the second water pipe adapter 1 from being disengaged from the outlet 53. The outlet valve 4 is connected to the first joint 11 of the second water pipe adapter 1 via the second water pipe 6. An inlet joint 41 is provided on a top of a valve core of the outlet valve 4, and the second water pipe 6 is connected between the inlet joint 41 and the first joint 11 of the second water pipe adapter 1. When the toilet needs to be flushed, the cleaning liquid in the dissolver 5 flows out of the second water pipe adapter 1 together with the water, and then the cleaning liquid or the cleaning solution enters the outlet valve 4 via the second water pipe 6. Finally, the cleaning liquid is flushed into the toilet via the outlet 4 to realize the cleaning.

Because the second joints 12 of the two water pipe adapters 1 can be rotatably adjusted relative to the inlet 52 and the outlet 53, respectively, the angles and the positions of the first joints 11 of the two water pipe adapters 1 can be adjusted. Thus, the two first joints 11 are directed away from each other to separate the two water pipes 6 to avoid the interferences. In addition, the second joint 12 of the second water pipe adapter 1 can also be adjusted to make the first joint 11 oblique upwards. This increases the height of the second water pipe 6 connected to the outlet joint 41 and avoids the contact interference between the second water pipe 6 and a housing of the outlet valve 4.

In an embodiment, the outlet joint 31 and the inlet joint 41 can adopt the above water pipe adapters 1, respectively, such that rotational connections can be achieved, respectively. Thus, a better fit between elements can be obtained.

In an embodiment, as shown in FIGS. 1-3 and 9, the interface position-limitation part 54 is or includes an interface baffle ring 541, and the joint position-limitation part 121 is or includes a joint baffle ring 1211.

An inner diameter of the interface baffle ring 541 is smaller than an outer diameter of the joint baffle ring 1211, and the joint baffle ring 1211 is located at an inner side of the interface baffle ring 541.

In this embodiment, the joint position-limitation part 121 is or includes the joint baffle ring 1211 integrally provided or formed on the second joint 12. The interface position-limitation part 54 is or includes the interface baffle ring 541 provided at an opening of the inlet 52 and an opening of the outlet 53. While the product is assembled, the joint baffle ring 1211 is located at the inner side of the interface baffle ring 541 to prevent the joint baffle ring 1211 from moving outwards.

In an embodiment, as shown in FIGS. 1-3, the annular grooves 122 are provided on the circumferential surfaces of the second joint 12, sealing rings are mounted in the annular grooves 122 to achieve the sealing between the second joint 12 of the first water pipe adapter 1 and the inlet 52 and the sealing between the second joint 12 of the second water pipe adapter 1 and the outlet 53.

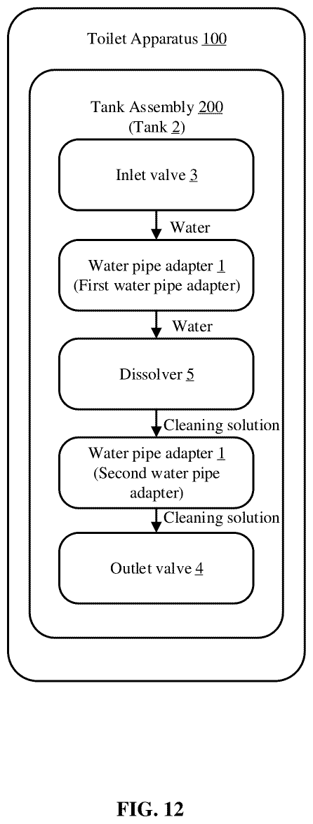

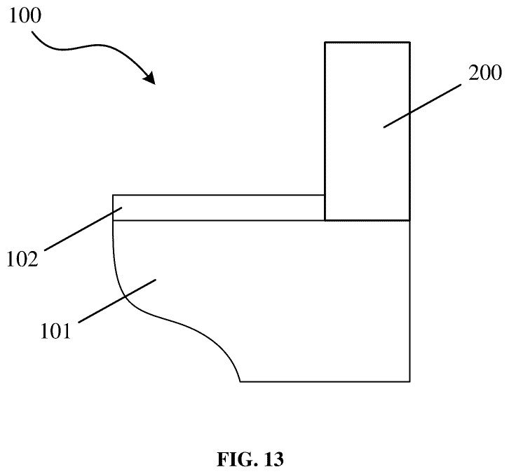

An embodiment of the present disclosure further provides a toilet apparatus 100. FIG. 12 is a block diagram of a toilet apparatus, including the water pipe adapter according to an embodiment of the present disclosure. FIG. 13 is a schematic view of the toilet apparatus according to an embodiment of the present disclosure. As shown in FIG. 12 and FIG. 13, the toilet apparatus 100 according to the present disclosure comprises a tank assembly 200, which may be the tank assembly as described in any of the above embodiments. The above descriptions regarding the tank assembly are incorporated herein.

The toilet apparatus 100 comprises a ceramic body and the tank assembly 200. The tank assembly 200 may be mounted at a backside of the ceramic body or may be mounted on the wall.

In an embodiment, the toilet apparatus 100 may include a base (e.g., a pedestal, a bowl, etc.) and a tank (e.g., the tank 2 as described above). The base is configured to be attached to another object such as a drainpipe, floor, or another suitable object. The base includes a bowl 101, a sump (e.g., a receptacle) disposed below the bowl, and a trapway fluidly connecting the bowl to a drainpipe or sewage line. The tank may be supported by the base, such as an upper surface of a rim. The tank may be integrally formed with the base as a single unitary body. In other embodiments, the tank may be formed separately from the base and coupled (e.g., attached, secured, fastened, connected, etc.) to the base. The toilet may further include a tank lid covering an opening and inner cavity in the tank. The toilet may include a seat assembly including a seat and a seat cover 102 rotatably coupled to the base. The toilet arrangement may further include a hinge assembly.

In another embodiment, the toilet arrangement may be a tankless toilet. The toilet arrangement includes a base and a seat assembly coupled to the base. The base includes a bowl, a sump disposed below the bowl, and a trapway fluidly connecting the bowl to a drainpipe or sewage line. The toilet arrangement includes a waterline that supplies the toilet with water. The toilet may further include a seat assembly including a seat and a seat cover rotatably coupled to the base. The toilets described above are provided herein as non-limiting examples of toilets that may be configured to utilize aspects of the present disclosure.

In some examples, a bidet may be included in a seat or pedestal of a toilet. In other examples, the bidet may be manufactured separately from and attached or coupled to a seat or pedestal of a toilet. The bidet includes a housing. The housing is configured to receive a flow of water through a housing inlet and dispense the flow of water from a housing outlet. The housing inlet and housing outlet may be located on opposite ends of the housing from one another, such that water may flow through the housing from the housing inlet to the housing outlet. In some examples, the housing further includes a chamber. As the housing receives the flow of water, the chamber may fill with water and provide a flow of water between the housing inlet and the housing outlet. The chamber may be configured to contain the flow of water and direct the flow of water from the housing inlet to the housing outlet. After the chamber has filled with water, the flow of water may travel along a substantially linear path between the housing inlet and the housing outlet. In some examples, one or more walls within the housing may be included to help direct a flow of water between the housing inlet and the housing outlet. The bidet may further include a housing inlet conduit configured to direct a flow of water to the housing inlet. The housing inlet conduit may be coupled to a water supply such as tank or waterline. The housing may further include a gear assembly or a portion of the gear assembly.

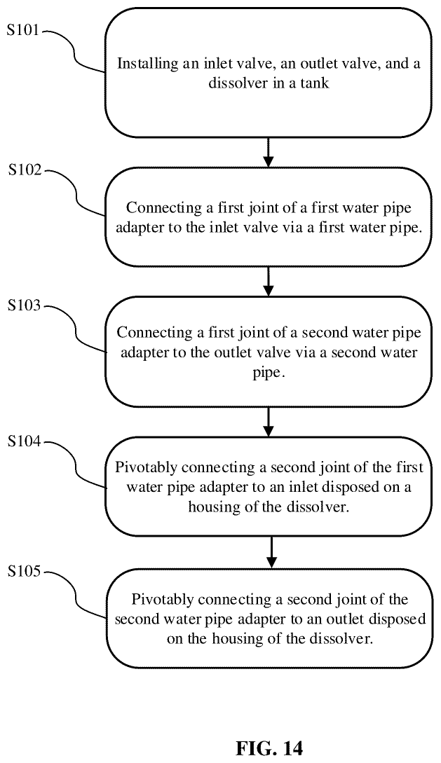

An embodiment of the present disclosure further provides a method for assembling a tank assembly. FIG. 14 is a flow chart of a method for assembling a tank assembly according to an embodiment of the present disclosure. The tank assembly in the method may be the tank assembly according to any of the foregoing embodiments, and the above descriptions regarding the tank assembly are incorporated herein. The tank assembly is configured to perform an operation, function, or the like as described in the present disclosure.

At act S101, the inlet valve 3, the outlet valve 4, and the dissolver 5 are installed in the tank 2.

Specifically, as described above, the tank 2 is configured to hold the water so as to flush the toilet. The inlet valve 3 is mounted in the tank 2 and configured to control the water supply into the tank 2. The outlet valve 4 is mounted in the tank 2 and configured to deliver the water to the toilet, so as to rinse or clean the toilet. The dissolver 5 is mounted in the tank 2 and configured receive and dissolve a solid detergent, so as to form a cleaning liquid or a cleaning solution.

At act S102, the first joint 11 of the first water pipe adapter 1 is connected to the inlet valve 3 via the first water pipe 6.

Specifically, as described above, one side of the inlet valve 3 is provided with the outlet joint 31. The first water pipe 6 is connected between the outlet joint 31 and the first joint 11 of the first water pipe adapter 1. The water from the outlet joint 31 enters the dissolver 5 through the first water pipe 6 and the first water pipe adapter 1, such that the solid detergent is dissolved to form the cleaning liquid or the cleaning solution.

At act S103, the first joint 11 of the second water pipe adapter 1 is connected to the outlet valve 4 via the second water pipe 6.

Specifically, as described above, the inlet joint 41 is provided on the top of the valve core of the outlet valve 4, and the second water pipe 6 is connected between the inlet joint 41 and the first joint 11 of the second water pipe adapter 1. When the toilet needs to be flushed, the cleaning liquid in the dissolver 5 flows out of the second water pipe adapter 1 together with the water, and then the cleaning liquid or the cleaning solution enters the outlet valve 4 via the second water pipe 6. Finally, the cleaning liquid is flushed into the toilet via the outlet 4 to realize the cleaning.

At act S104, the second joint 12 of the first water pipe adapter 1 is pivotably connected to the inlet 52 disposed on the housing 51 of the dissolver 5.

Specifically, as described above, the second joint 12 of the first water pipe adapter 1 is pivotably mounted in the inlet 52, and the second joint 12 of the first water pipe adapter 1 may be sealed with the inlet 52 via a sealing ring. The joint position-limitation part 121 is fitted with or engaged with the interface position-limitation part 54 of the first water pipe adapter 1 to prevent the second joint 12 from being disengaged from the inlet 52.

At act S105, the second joint 12 of the second water pipe adapter 1 is pivotably connected to the outlet 53 disposed on the housing 51 of the dissolver 5.

Specifically, as described above, the second joint 12 of the second water pipe adapter 1 is pivotably mounted in the outlet 53, and a seal is formed between the second joint 12 and the inlet 52 via sealing rings. The joint position-limitation part 121 is fitted with or engaged with the interface position-limitation part 54 of the second water pipe adapter 1 to prevent the second joint 12 of the second water pipe adapter 1 from being disengaged from the outlet 53.

Although the above steps of the method for assembling the tank assembly are described to be sequentially performed, the steps merely instantiate the technical idea of some embodiments of the present disclosure. Therefore, a person having ordinary skill in the art could perform the steps by changing the sequences described in the respective drawings or by performing two or more of the steps in parallel. Thus, the steps described above are not limited to the illustrated sequence.

Depending on requirements, the above technical solutions may be in combination with each other to achieve an optimal technical effect.

The above description are merely the principle and optimal embodiments of the present disclosure. It should be noted that, for those having ordinary skill in the art, based on the principle of the present disclosure, other variations can also be made and should also be considered as falling into the protection scope of the present disclosure.

1-10. (canceled)

11. A water pipe adapter, comprising:
a first joint comprising a position-limiting projection part configured to be connected to a water pipe; and
a second joint, connected to the first joint and comprising a joint position-limitation part configured to be engaged with an interface position-limitation part of an inlet or an interface position-limitation part of an outlet, the second joint configured to be pivotably disposed in the inlet or the outlet.

12. The water pipe adapter according to claim 11, wherein the joint position-limitation part is an annular protrusion extending outwards from an outer surface of the second joint,
wherein the interface position-limitation part of the inlet is an annular protrusion extending inwards from an inner wall of the inlet, and
wherein the interface position-limitation part of the outlet is an annular protrusion extending inwards from an inner wall of the outlet.

13. The water pipe adapter according to claim 11, wherein the first joint obliquely extends toward one side of the second joint, and
wherein an angle formed between an axis of the first joint and an axis of the second joint is an obtuse angle.

14. The water pipe adapter according to claim 11, further comprising:
an annular groove configured to receive a sealing ring and disposed on a circumferential surface of the second joint,
wherein the joint position-limitation part is disposed between the annular groove and the first joint.

15. The water pipe adapter according to claim 14, wherein a plurality of annular grooves are disposed on the second joint along an axial direction of the second joint and spaced part from each other.

16. The water pipe adapter according to claim 11, wherein the joint position-limitation part comprises a joint baffle ring integrally formed on the second joint.

17. The water pipe adapter according to claim 11, wherein the position-limiting projection part comprises a position-limiting projecting ring integrally formed on the first joint,
wherein a ring surface of the position-limiting projecting ring is an inclined plane, and
wherein a radius of the ring surface of the position-limiting projecting ring increases along a direction from the first joint to the second joint.

18. The water pipe adapter according to claim 11, wherein the first joint is injection-molded with the second joint.

19. A tank assembly, comprising:
a tank;
a dissolver, disposed in the tank and comprising a housing;
an inlet, disposed on the housing of the dissolver and comprising an interface position-limitation part;
an outlet, disposed on the housing of the dissolver and comprising an interface position-limitation part;
a first water pipe adapter, comprising:
a first joint comprising a position-limiting projection part configured to be connected to a first water pipe; and
a second joint comprising a joint position-limitation part configured to be engaged with the interface position-limitation part of the inlet, the second joint configured to be pivotably disposed in the inlet,
a second water pipe adapter, comprising:
a first joint comprising a position-limiting projection part configured to be connected to a second water pipe; and
a second joint comprising a joint position-limitation part configured to be engaged with the interface position-limitation part of the outlet, the second joint configured to be pivotably disposed in the outlet,
an inlet valve, disposed in the tank and configured to be connected to the first joint of the first water pipe adapter disposed in the inlet via the first water pipe; and
an outlet valve, disposed in the tank and configured to be connected to the first joint of the second water pipe adapter disposed in the outlet via the second water pipe.

20. The tank assembly according to claim 19, wherein the interface position-limitation part of the inlet and the interface position-limitation part of the outlet each comprise an interface baffle ring,
wherein the joint position-limitation part of the first water pipe adapter and the joint position-limitation part of the second water pipe adapter each comprise a joint baffle ring,
wherein an inner diameter of the interface baffle ring of the inlet is less than an outer diameter of the joint baffle ring of the first water pipe adapter,
wherein an inner diameter of the interface baffle ring of the outlet is less than an outer diameter of the joint baffle ring of the second water pipe adapter,
wherein when the joint position-limitation part of the first water pipe adapter is engaged with the interface position-limitation part of the inlet, the joint baffle ring of the outlet is disposed at an inner side of the interface baffle ring of the first water pipe adapter, and
wherein when the joint position-limitation part of the second water pipe adapter is engaged with the interface position-limitation part of the outlet, the joint baffle ring of the outlet is disposed at an inner side of the interface baffle ring of the second water pipe adapter.

21. The tank assembly according to claim 19, further comprising:
an annular groove disposed on a circumferential surface of the second joint of each of the first water pipe adapter and the second water pipe adapter; and
a sealing ring disposed in each of the annular groove of the first water pipe adapter and the annular groove of the second water pipe adapter.

22. The tank assembly according to claim 21, wherein a plurality of annular grooves are disposed on the second joint along an axial direction of the second joint and spaced part from each other.

23. The tank assembly according to claim 19, wherein the first joint obliquely extends toward one side of the second joint, and
wherein an angle formed between an axis of the first joint and an axis of the second joint is an obtuse angle.

24. The tank assembly according to claim 19,
wherein water from the inlet enters the dissolver through the first water pipe, the first water pipe adapter, and the inlet to dissolve a solid detergent in the dissolver to form a cleaning solution, and
wherein the cleaning solution enters the outlet valve through the outlet, the second water pipe adapter, and the outlet valve to flush a toilet.

25. The tank assembly according to claim 24, wherein the first joint obliquely extends toward one side of the second joint, and
wherein an angle formed between an axis of the first joint and an axis of the second joint is an obtuse angle.

26. A method for assembling a tank assembly comprising a tank, the method comprising:
installing an inlet valve, an outlet valve, and a dissolver in the tank;
connecting a first joint of a first water pipe adapter to the inlet valve via a first water pipe;
connecting a first joint of a second water pipe adapter to the outlet valve via a second water pipe;
pivotably connecting a second joint of the first water pipe adapter to an inlet disposed on a housing of the dissolver; and
pivotably connecting a second joint of the second water pipe adapter to an outlet disposed on the housing of the dissolver.

27. The method according to claim 26,
wherein pivotably connecting the second joint of the first water pipe adapter to the inlet disposed on the housing of the dissolver comprises:
engaging a joint position-limitation part of the second joint of the first water pipe adapter with an interface position-limitation part of the inlet, and
wherein pivotably connecting the second joint of the second water pipe adapter to the outlet disposed on the housing of the dissolver comprises:
engaging a joint position-limitation part of the second joint of the second water pipe adapter with an interface position-limitation part of the outlet.

28. The method according to claim 27,
wherein pivotably connecting the second joint of the first water pipe adapter to the inlet disposed on the housing of the dissolver further comprises:
rotating the second joint of the first water pipe adapter with respect to the inlet to adjust an angle of the first joint of the first water pipe adapter, and
wherein pivotably connecting the second joint of the second water pipe adapter to the outlet disposed on the housing of the dissolver further comprises:
rotating the second joint of the second water pipe adapter with respect to the outlet to adjust an angle of the first joint of the second water pipe adapter.

29. The method according to claim 26, further comprising:
assembling a sealing ring in at least one annular groove disposed on a circumferential surface of the second joint of the first water pipe adapter; and
assembling a sealing ring in at least one annular groove disposed on a circumferential surface of the second joint of the second water pipe adapter.

30. The method according to claim 26,
wherein connecting the first joint of the first water pipe adapter to the inlet valve via the first water pipe comprises:
connecting the first water pipe to an outlet joint of the inlet valve, and
wherein connecting the first joint of the second water pipe adapter to the outlet valve via the second water pipe comprises:
connecting the second water pipe to an inlet joint of the outlet valve.
